(19) United States
(12) Patent Application Publication
(10) Pub. No.: US 2013/0259114 A1
(43) Pub. Date: Oct. 3, 2013

(54) Encoding and Transmitting Video Streams

(71) Applicants: Pontus Carlsson, Bromma (SE); Andrei Jefremov, Jarfalla (SE); Sergey Sablin, (US); David Zhao, Solna (SE)

(72) Inventors: Pontus Carlsson, Bromma (SE); Andrei Jefremov, Jarfalla (SE); Sergey Sablin, (US); David Zhao, Solna (SE)

(21) Appl. No.: 13/536,346

(22) Filed: Jun. 28, 2012

(30) Foreign Application Priority Data
Mar. 27, 2012 (GB) 1205395.5

(51) Int. Cl. H04N 11/02

(52) U.S. Cl. 375/240.01; 375/E07.026

(57) ABSTRACT

The invention relates to a method of encoding a video stream comprising, receiving a video signal comprising a plurality of frames, each frame comprising one or more portion of video data displaying to a user a video image derived from the video signal; receiving from the user selection of at least one region in the video image, the region represented by a portion of video data; and encoding the video signal, said encoding comprising encoding the portion of video data corresponding to the at least one selected region at a higher quality level than other portions of the video data in the video stream.

### RELATED APPLICATION

This application claims priority under 35 USC 119 or 365 to Great Britain Application No. 1205395.5 filed 27 Mar. 2012, the disclosure of which is incorporated in its entirety.

### BACKGROUND

In the transmission of video streams, efforts are continually being made to reduce the amount of data that needs to be transmitted whilst still allowing the moving images to be adequately recreated at the receiving end of the transmission. A video encoder receives an input video stream comprising a sequence of “raw” video frames to be encoded, each representing an image at a respective moment in time. The encoder then encodes each input frame into one of two types of encoded frame: either an intra frame (also known as a key frame), or an inter frame. The purpose of the encoding is to compress the video data so as to incur fewer bits when transmitted over a transmission medium or stored on a storage medium.

An intra frame is compressed using data only from the current video frame being encoded, typically using intra frame prediction coding whereby one image portion within the frame is encoded and signaled relative to another image portion within that same frame. This is similar to static image coding. An inter frame on the other hand is compressed using knowledge of a preceding frame (a reference frame) and allows for transmission of only the differences between that reference frame and the current frame which follows it in time. This allows for much more efficient compression, particularly when the scene has relatively few changes. Inter frame prediction typically uses motion estimation to encode and signal the video in terms of motion vectors describing the movement of image portions between frames, and then motion compensation to predict that motion at the receiver based on the signaled vectors. Various international standards for video communications such as MPEG 1, 2 & 4, and H.261, H.263 & H.264 employ motion compensation based on regular block based partitions of source frames.

Depending on the resolution, frame rate, bit rate and scene, an intra frame can be up to 20 to 100 times larger than an inter frame. On the other hand, an inter frame imposes a dependency relation to previous inter frames up to the most recent intra frame. If any of the frames are missing, decoding the current inter frame may result in errors and artifacts. These techniques are used for example in the H.264/AVC standard.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments achieve a compromise between quality and bandwidth by selecting portions of an image where a higher quality it needed. In particular, that in at least some embodiments, a user can select those portions, thereby enhancing manually any automated compromises effected at the encoder.

In one or more embodiments, a method of encoding a video stream comprises receiving a video signal comprising a plurality of frames. Each frame comprises one or more portion of video data. A video image derived from the video signal is displayed to a user. A user selection of at least one region in the video image is received and is represented by a portion of video data. The video signal is encoded, with the portion of video data corresponding to the selection being encoded at a higher quality level than other portions of the video data in the video stream. A computer program product may be provided for implementing the above method.

Encoding at a higher quality level can take place in a number of different ways, for example using preprocessing, a longer encode time, or in the case of scalable coding adding another quality level. According to the described embodiment, the increased quality is provided by altering a quantization parameter, but this is intended by way of non-limiting example only. The process of quantization organizes the transform coefficients in the transformed domain into sets (or bins) based on their amplitude. It will typically be the case that many of the transform coefficients are zero or have low amplitude and can thus be represented with a small amount of data. The quantizer “grain” is the size of each set (or bin), controlled by a quantization step Q step, that is, the range of amplitudes assigned to that set. A small quantizer grain implies a good quality, but more data to transmit whereas a larger grain denotes less data but at the expense of quality.

### BRIEF DESCRIPTION OF THE DRAWINGS

For a better understanding of the described embodiments and to show how the same may be carried into effect, reference will now be made by way of example, to the accompanying drawings.

FIG. 1 is a schematic block diagram of an encoder;

FIG. 2 is a schematic block diagram of a decoder;

FIG. 3 is a schematic diagram of a communication system;

FIG. 4 is a functional block diagram of a user terminal;

FIG. 5 is a schematic illustration of two frames of a video stream;

FIG. 6A shows the pixel values of blocks represented in the spatial domain; and

FIG. 6B shows coefficients of blocks represented in the frequency domain;

### DETAILED DESCRIPTION

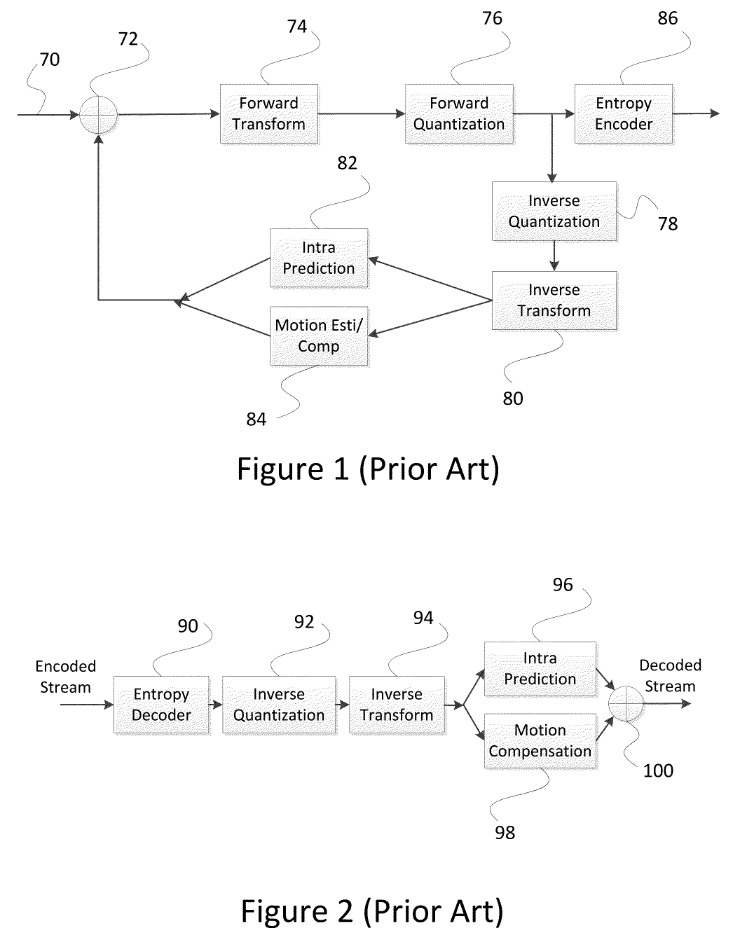

FIG. 1 illustrates a known video encoder for encoding a video stream into a stream of inter frames and interleaved intra frames, e.g. in accordance with the basic coding structure of H.264/AVC. The encoder receives an input video stream comprising a sequence of frames to be encoded (each divided into constituent macroblocks and subdivided into blocks), and outputs quantized transform coefficients and motion data which can then be transmitted to the decoder. The encoder comprises an input 70 for receiving an input macroblock of a video image, a subtraction stage 72, a forward transform stage 74, a forward quantization stage 76, an inverse quantization stage 78, an inverse transform stage 80, an intra frame prediction coding stage 82, a motion estimation & compensation stage 84, and an entropy encoder 86.

The subtraction stage 72 is arranged to receive the input signal comprising a series of input macroblocks, each corresponding to a portion of a frame. From each, the subtraction stage 72 subtracts a prediction of that macroblock so as to generate a residual signal (also sometimes referred to as the prediction error). In the case of intra prediction, the prediction of the block is supplied from the intra prediction stage 82 based on one or more neighboring regions of the same frame (after feedback via the reverse quantization stage 78 and reverse transform stage 80). In the case of inter prediction, the prediction of the block is provided from the motion estimation & compensation stage 84 based on a selected region of a preceding frame (again after feedback via the reverse quantization stage 78 and reverse transform stage 80). For motion estimation the selected region is identified by means of a motion vector describing the offset between the position of the selected region in the preceding frame and the macroblock being encoded in the current frame.

The forward transform stage 74 then transforms the blocks of the residual signal from a spatial domain representation into a transform domain representation, e.g. by means of a discrete cosine transform (DCT). That is to say, it transforms each residual block from a set of pixel values at different Cartesian x and y coordinates to a set of coefficients representing different spatial frequency terms. The forward quantization stage 76 then quantizes the transform coefficients, and outputs quantized and transformed coefficients of the residual signal to be encoded into the video stream via the entropy encoder 86, to thus form part of the encoded video signal for transmission to one or more recipient terminals.

Furthermore, the output of the forward quantization stage 76 is also fed back via the inverse quantization stage 78 and inverse transform stage 80. The inverse transform stage 80 transforms the residual coefficients from the frequency domain back into spatial domain values where they are supplied to the intra prediction stage 82 (for intra frames) or the motion estimation & compensation stage 84 (for inter frames). These stages use the reverse transformed and reverse quantized residual signal along with knowledge of the input video stream in order to produce local predictions of the intra and inter frames (including the distorting effect of having been forward and reverse transformed and quantized as would be seen at the decoder). This local prediction is fed back to the subtraction stage 72 which produces the residual signal representing the difference between the input signal and the output of either the local intra frame prediction stage 82 or the local motion estimation & compensation stage 84. After transformation, the forward quantization stage 76 quantizes this residual signal, thus generating the quantized, transformed residual coefficients for output to the entropy encoder 86. The motion estimation stage 84 also outputs the motion vectors via the entropy encoder 86 for inclusion in the encoded bitstream.

When performing intra frame encoding, the idea is to only encode and transmit a measure of how a portion of image data within a frame differs from another portion within that same frame. That portion can then be predicted at the decoder (given some absolute data to begin with), and so it is only necessary to transmit the difference between the prediction and the actual data rather than the actual data itself. The difference signal is typically smaller in magnitude, so takes fewer bits to encode.

In the case of inter frame encoding, the motion compensation stage 84 is switched into the feedback path in place of the intra frame prediction stage 82, and a feedback loop is thus created between blocks of one frame and another in order to encode the inter frame relative to those of a preceding frame. This typically takes even fewer bits to encode than an intra frame.

FIG. 2 illustrates a corresponding decoder which comprises an entropy decoder 90 for receiving the encoded video stream into a recipient terminal, an inverse quantization stage 92, an inverse transform stage 94, an intra prediction stage 96 and a motion compensation stage 98. The outputs of the intra prediction stage and the motion compensation stage are summed at a summing stage 100.

In transmission of video streams there is a compromise between available bandwidth for transmitting data and required quality when encoding video data.

This compromise can be effected in a number of different ways when processing and encoding video data.

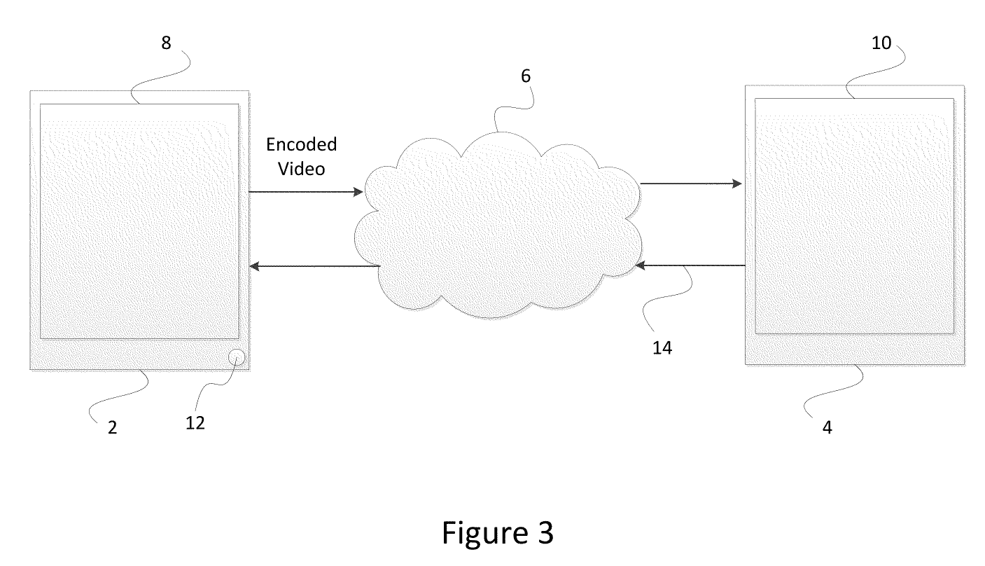

FIG. 3 is a schematic block diagram of a communication system wherein a user terminal 2 is arranged to transmit data to a user terminal 4 via a communication network, for example, a packet-based network such as the Internet 6.

Other forms of communication network are possible, and aspects of the present invention can be used with a mobile signal network such as GSM.

Each user terminal 2, 4 comprises a display 8, 10 respectively and the sender terminal 2 can also comprise a camera 12 for capturing moving images which can be displayed on the screen 8 as a video, and/or transmitted to the terminal 4 for display on the screen 10. It will be appreciated that FIG. 3 is highly schematic and is not intended to represent accurately any particular device. User terminals of the general type are known in the art. In one embodiment, the displays 8, 10 also constitute a user interface using touch screen technology, although it will be appreciated that other user interfaces can be utilized, for example, a keyboard, mouse, etc.

Various embodiments transmit video data from the user terminal 2 to the user terminal 4 via the communication network 6. In particular, various embodiments allow a user to determine which part of the video is important in that it is to be processed at a higher quality level. This part is encoded with higher quality prior to transmission. In one embodiment, the user which determines the part of the video that is to be processed at a higher quality level is the sender (user of sending terminal 2). In this case, he selects a region or area of the video image on display 8 using the user interface (for example by clicking (with a mouse/cursor interface) or touching the centre of the area of interest with touch screen technology). As described in more detail in the following, information defining the region or area of interest is supplied to the encoder 16 (FIG. 2) which operates to encode the region with higher quality.

The region of interest can be an area of a particular size, or an object in the image.

In another embodiment, a user of the receiving terminal 4 defines the region of interest. In this case, information identifying the region of interest or object of interest is transmitted to the sending terminal 2, such that the encoder 16 at the sending terminal can be notified accordingly. This communication is noted by reference numeral 14 in FIG. 3.

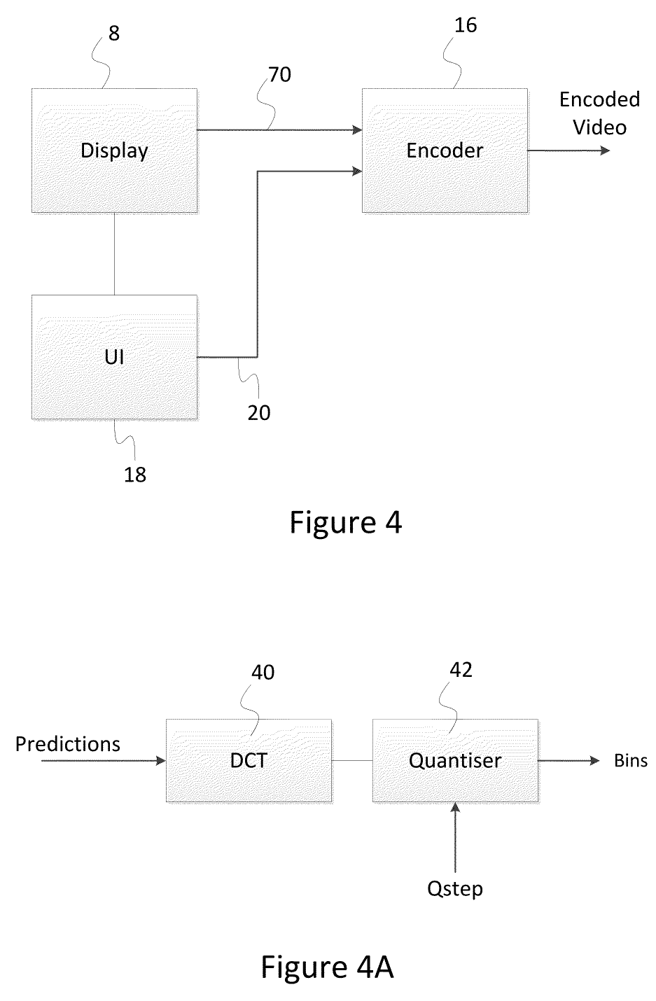

FIG. 4 is a schematic block diagram of functional blocks at the user terminal 2. It is assumed that the video to be transmitted from the sender terminal 2 is being displayed to a user on display 8 prior to transmission. Reference numeral 18 denotes a user interface with which the user can select regions of interest or objects on the display 8. Such selections 20 are supplied to an encoder 16 with the video stream 70. The encoder 16 can be for example as illustrated in FIG. 1, but the various embodiments are not restricted to this and any form of encoder can be utilized. The encoder 16 has the possibility to encode different portions of the video data at different levels of quality. In accordance with various embodiments, the encoder 16 operates to encode the video stream 70 at a first quality level, apart from the selected regions of interest which are encoded at a second, higher quality level. One way in which the quality level can be altered is discussed in more detail in the following.

When the user selection is made at the receiving terminal 4 rather than the sending terminal 2, the information concerning the selected regions of interest is supplied to the encoder 16 using signal 14 or a signal derived from that signal at the sending terminal.

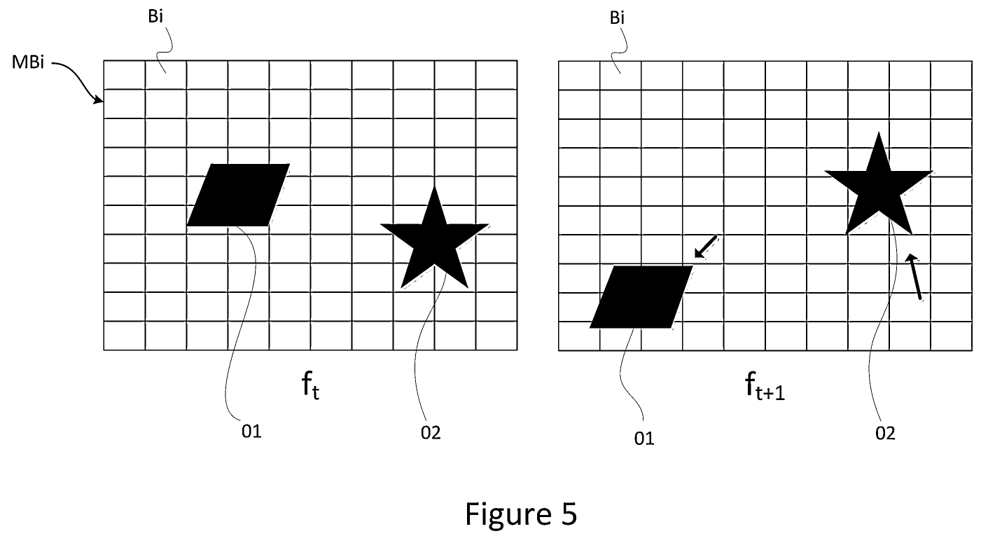

FIG. 5 schematically illustrates two successive frames ft and ft+1 of a video image at two respective moments in time t and t+1. For the purpose of inter frame prediction the first frame ft may be considered a reference frame, i.e. a frame which has just been encoded from a moving sequence at the encoder, or a frame which has just been decoded at the decoder. The second frame ft+1 may be considered a target frame, i.e. the current frame whose motion is sought to be estimated for the purpose of encoding or decoding. An example with two moving objects is shown for the sake of illustration.

Each frame is comprised of macroblocks MBi, each of which comprises an array of blocks Bi.

The objects are denoted 01 and 02 respectively. In the present case, a user can select object 01 for enhanced encoding using the user interface as described above. In the following encode process, the encoder uses information identifying that object to encode it with a higher quality. The information can take different forms, depending on how a user selects the object or region of interest. In the case that an object is selected by a user clicking it, one example would be that the block address is sent to the encoder, which in turn determines the borders of the object by e.g. edge detection.

The object 01 could alternatively be marked by the user roughly marking the region specifying an area surrounding it for example, using something similar to a photo shoot “lasso” tool which is known for use with static images to identify an area for enhancement or cropping, etc. This would utilize software loaded at the user terminal to carry out such marking in cooperation with the displayed image. In case a “lasso” tool is used, the addresses of the included macroblocks could be used as the information supplied to the encoder.

The quality level used to encode the identified object is kept as the object moves because the encoder can track the object using its identification. For example, once the object has been identified by e.g. edge detection, motion vectors from motion estimation may be used to keep track of it, possibly in combination with edge detection, e.g. if the object is transformed (zoomed/squeezed).

Video encoding is itself known in the art and so is described herein only to the extent necessary to provide suitable background for the described embodiments. According to International Standards for Video Communications such as MPEG 1, 2 & 4 and H.261, H.263 & H.264, video encoding comprises individual reference blocks, and differentials between reference and predicted blocks, together with motion estimation. Motion estimation is based on block-based partitions of source frames. For example, each block Bi may comprise an array of 4×4 pixels, or 4×8, 8×4, 8×8, 16×8, 8×16 or 16×16 in various other standards. An exemplary block is denoted by Bi in FIG. 5. The number of pixels per block can be selected in accordance with the required accuracy and decode rates. The selection is typically done using rate-distortion optimization, i.e. to achieve the lowest distortion for the current bit rate, in a manner known per se. Each pixel can be represented in a number of different ways depending on the protocol adopted in accordance with the standards. In the example herein, each pixel is represented by chrominance (U and V) and luminance (Y) values (though other possible colour-space representations are also known in the art). In this particular example chrominance values are shared by four pixels in a block. A macroblock MBi typically comprises four blocks, e.g. an array of 8×8 pixels for 4×4 blocks or an array of 16×16 pixels for 8×8 blocks. As described above with reference to FIG. 1, blocks are transformed and quantized prior to transmission. Each quantized block has an associated bit rate which is the amount of data needed to transmit information about that block.

A current block is encoded based on a reference block by means of prediction coding, either intra-frame coding in the case where the reference block is from the same frame ft+1 or inter-frame coding where the reference block is from a preceding frame ft (or indeed ft−1, or ft−2, etc.).

A frequency domain transform is performed on each portion of the image of each of a plurality of frames, e.g. on each block. Each block is initially expressed as a spatial domain representation whereby the chrominance and luminance of the block are represented as functions of spatial x and y coordinates, U(x,y), V(x,y) and Y(x,y) (or other suitable colour-space representation). That is, each block is represented by a set of pixel values at different spatial x and y coordinates. A mathematical transform is then applied to each block to transform into a transform domain representation whereby i.e. the block is transformed to a set of coefficients representing different spatial frequency terms. Possibilities for such transforms include the Discrete Cosine Transform (DCT), Karhunen-Loeve Transform (KLT), or others. E.g. a DCT can be implemented by the matrix multiplication.

A.X.A^{T}

Where X is the block matrix, A is the transform matrix and AT is its transpose. In the H.264 standard, the transform process is organized into a core part and a scaling part to minimum complexity.

In the transform domain each block can be encoded as a set of spatial frequency terms having different amplitude coefficients Ynx,ny (and similarly for U and V). Hence the transform domain may be referred to as the frequency domain (in this case referring to spatial frequency).

In some embodiments, the transform could be applied in three dimensions. A short sequence of frames effectively form a three dimensional cube or cuboid U(x,y,t), V(x,y,t) and Y(x,y,t). The term “frequency domain” may be used herein may be used to refer to any transform domain representation in terms of spatial frequency transformed from a spatial domain and/or temporal frequency transformed from a temporal domain.

After transformation, the coefficients in the frequency domain are quantised. FIG. 4A illustrates schematically the encoder blocks for performing transformation (DCT block 40) and quantization (quantizer 42).

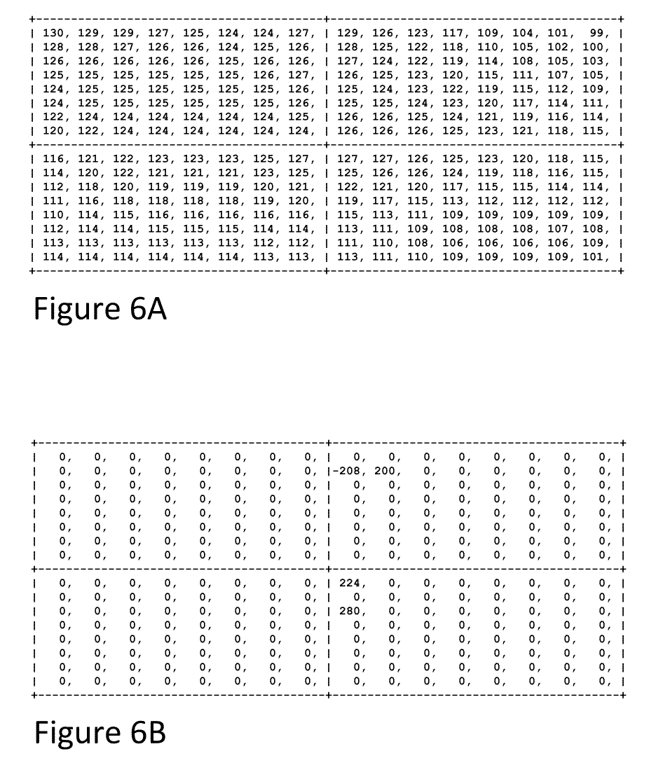

Consider an illustrative case as shown in FIGS. 6A and 6B. Here, the representation of a block in the frequency domain is achieved through a transform which converts the spatial domain pixel values to spatial frequencies. FIG. 6A shows some example pixel values of four 8×8 blocks in the spatial domain, e.g. which may comprise the luminance values Y(x, y) of individual pixels at the different pixel locations x and y within the block. FIG. 6B is the equivalent in the frequency domain after transform and quantization. Quantization may be performed, for example, using a basic uniform quantizer, which processes frequency domain coefficients in accordance with the following formula:

$$Q ( X ) = sgn ( X ) \cdot Δ \cdot ⌊ \frac{\vert X \vert}{Δ} + \frac{1}{2} ⌋$$

where Δ is the Q step and sgn( ) is the sign function. With Δ=1, the effect of this quantizer is to round X to the nearest integer value. The value of Δ may be dynamically varied. To perform quantization, each input X (frequency domain coefficient) is classified by a value k=Q(X). Each k value defines a quantization bin. As Δ increases, so does the number of frequency domain coefficients that are assigned the same quantization bin, resulting in courser graining and therefore lower quality. In embodiments that use this quantization scheme, the quality of a given pixel block Bi/group of pixel blocks, or alternatively a given macroblock MBi/group of macroblocks, may therefore be varied by varying Δ for the respective block/blocks. In alternative embodiments, Q steps for each frequency domain coefficient may be provided by quantization matrices as is known in the art. The relevant quantization matrices may then be changed to allow higher grain quantization for selected objects. In FIG. 6B such coefficients may represent the quantized amplitudes Ynx,ny of the different possible frequency domain terms. The size of the block in spatial and frequency domain is the same, i.e. in this case 8×8 values or coefficients.

It will be appreciated that while blocks and macroblocks are referred to herein, the techniques can similarly be used on other portions definable in the image. Frequency domain separation in blocks and/or portions may be dependent on the choice of transform. In the case of block transforms, for example, like the Discrete Cosine transform (DCT) and Karhunen-Loeve Transform (KLT) and others, the target block or portions becomes an array of fixed or variable dimensions. Each array comprises a set of transformed quantized coefficients. According to the H264 standard, luminance and chrominance blocks are equal in number. That means they will contain different number of pixels in case of 4.2.0 sampling and use different size transforms.

Once the current target block has been encoded relative to the reference block, the residual of the frequency domain coefficients is output via an entropy encoder for inclusion in the encoded bitstream. In addition, side information is included in the bitstream in order to identify the reference block from which each encoded block is to be predicted at the decoder. The side information is in the form of motion vector, which is signaled in the form of a small vector relative to the current block, the vector being any number of pixels of fractional pixels. The quantization level is also signaled to the decoder. This can be signaled as a Q step value, a quantization matrix, or as a parameter by which an existing quantization matrix is scaled.

Other ways of increasing quality of the selected region can be applied at the encoder, for example using a longer encode time or in the case of scalable coding adding another quality level. The quality of a region or area may also be altered by pre-processing. For instance, pre-processing may comprise blurring of non-important regions outside of the selected region or area of importance. The blur makes the non-important regions cheaper to encode as it reduces their high frequency content.

As described herein there may be provided a method of encoding a video stream comprising: receiving a video signal comprising a plurality of frames, each frame comprising one or more portion of video data; displaying to a user a video image derived from the video signal; receiving from the user selection of at least one region in the video image, the region represented by a portion of video data; and, encoding the video signal, said encoding comprising encoding the portion of video data corresponding to the at least one selected region at a higher quality level than other portions of the video data in the video stream.

There may also be provided a computer program product embodied on a non-transient computer-readable storage medium, e.g., a hardware medium, for implementing the above steps.

In one embodiment, the video image is displayed to a user at a sending terminal and the user at the sending terminal selects said at least one region. Thus, there may be provided a user device comprising means for generating a video signal comprising a plurality of frames, each frame comprising one or more portion of video data; means for displaying to the user a video image derived from the video signal; means for receiving from the user selection of at least one region in the video image, the region represented by a portion of video data; and means for encoding the video signal while encoding the portion of video data corresponding to the at least one selected region at a higher quality level than other portions of the video data in the video stream.

In an alternative embodiment, the video image is displayed at a receiving terminal, a user at the receiving terminal selecting said at least one region and notifying a sending terminal of said at least one region.

Accordingly, there may also be provided a user device for generating a video signal comprising a plurality of frames, each frame comprising one or more portion of video data; means for receiving from a viewer of a video image derived from the video signal selection of at least one region in the video image, the region represented by a portion of video data; and means for encoding the video signal while encoding the portion of video data corresponding to the at least one selected region at a higher quality level than other portions of the video data in the video stream; and means for transmitting the encoded video stream to the viewer.

There may also be provided a user device comprising means for receiving an encoded video stream comprising video data; means for displaying to a user a video image derived from the video stream; means for receiving from the user selection of at least one region in the video image, the region represented by a portion of video data; and means for transmitting the user selection to a source of the video data.

There may also be provided an encoder for encoding a video stream comprising; means for receiving a video signal comprising a plurality of frames, each frame comprising one or more portion of video data; means for receiving from a user selection of at least one region in the video image, the region represented by a portion of video data; and means for encoding the video signal, said means arranged to receive an indication of the at least one selected region and operable to encode the portion of video data corresponding to the at least one selected region at a higher quality level than other portions of the video data in the video stream.

There may also be provided a computer program product comprising program code means which when executed by a processor carry out the steps of: encoding a video signal comprising a plurality of frames, each frame comprising one or more portion of video data, to generate an encoded video stream; transmitting the encoded video stream to a viewer; receiving from the viewer of a video image derived from the video stream selection of at least one region in the video image, the region represented by a portion of video data; and encoding a portion of video data corresponding to at least one selected region at a higher quality level than other portions of the video data in the video stream.

There may also be provided a computer program product comprising program code means which when executed by a processor carries out the following steps: receiving an encoded video stream comprising video data; displaying to a user a video image derived from the video stream; receiving from the user selection of at least one region in the video image, the region represented by a portion of video data; and transmitting the user selection to a source of the video data.

It will readily be appreciated that the invention can be implemented using hardware, firmware or software in any appropriate combination. In particular, the user terminal can comprise a processor which is arranged to execute code capable of implementing the encoder described in the foregoing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer program product configured to encode a video stream, the computer program product being embodied on a computer-readable hardware medium and comprising program code means which when executed by a processor carry out the operations of:
receiving a video signal comprising a plurality of frames, each frame comprising one or more portion of video data;
displaying to a user a video image derived from the video signal;
receiving from the user selection of at least one region in the video image, the region represented by a portion of video data; and,
encoding the video signal, said encoding comprising encoding the portion of video data corresponding to the at least one selected region at a higher quality level than other portions of the video data in the video stream.

2. A computer program product according to claim 1, wherein said displaying a video image comprises displaying the video image to a user at a sending terminal and receiving the user selection comprises receiving the selection via the sending terminal.

3. A computer program product according to claim 1, wherein said displaying a video image comprises displaying the video image at a receiving terminal, receiving said selection at the receiving terminal selecting and wherein the computer program product further comprises program code means which when executed by the processor notify a sending terminal of said at least one region.

4. A computer program product according to claim 1, wherein said receiving from the user selection of said at least one region comprises receiving a user selection from at least one of:
a touch screen;
a keyboard;
a mouse; or
software means for marking the image.

5. A computer program product according to claim 1, wherein said encoding the at least one selected region at a higher quality level is carried out by increasing a quantization grain for quantization of a transformed portion of video data corresponding to said at least one region.

6. A computer program product according to claim 1, wherein the said at least one region comprises an object, the computer program product further comprising program code means which when executed by the processor track the object in subsequent portions of the video data for higher quality encoding.

7. A computer program product according to claim 1, wherein the at least one selected region is identified by an address of the region.

8. A computer program product according to claim 7, wherein each frame of the video signal comprises a plurality of blocks, and the at least one selected region is identified by an address of at least one block.

9. A computer program product according to claim 1, wherein the computer program product further comprises program code means which when executed by the processor transmit the video stream to a decoder and include in the video stream an indication of the higher quality level of the at least one selected region for use at the decoder.

10. A computer program product according to claim 8, wherein said encoding the at least one selected region at a higher quality level is carried out by increasing a quantization grain for quantization of a transformed portion of video data corresponding to said at least one region, and wherein the indication of the higher quality level comprises a quantization parameter.

11. An encoder configured to encode a video stream comprising:
a receiver configured to receive a video signal comprising a plurality of frames, each frame comprising one or more portion of video data;
a user interface block configured to receive from a user selection of at least one region in the video image, the region represented by a portion of video data; and
an encoder block configured to encode the video signal, said encoder block arranged to receive an indication of the at least one selected region and operable to encode the portion of video data corresponding to the at least one selected region at a higher quality level than other portions of the video data in the video stream.

12. An encoder according to claim 11, wherein the at least one region comprises an object and the encoder comprises a tracking block configured to track the object and associated portions of the video data for higher quality encoding.

13. An encoder according to claim 11, comprising a quantizer operable to receive an indication of a quantization grain for encoding the video stream, the quantizer operable to encode the at least one selected region at a higher quality level by using an increased quantization grain for quantization of a transformed portion of video data corresponding to said at least one region.

14. An encoder according to claim 13, comprising a transforming block configured to transform the video data from a time domain to a frequency domain prior to said quantization.

15. A user device comprising:
a video signal generating block configured to generate a video signal comprising a plurality of frames, each frame comprising one or more portion of video data;
a display configured to display to the user a video image derived from the video signal;
a user interface block configured to receive from the user selection of at least one region in the video image, the region represented by a portion of video data; and
an encoder block configured to encode the video signal while encoding the portion of video data corresponding to the at least one selected region at a higher quality level than other portions of the video data in the video stream.

16. A user device according to claim 15, comprising a transmitter configured to transmit the encoded video stream to a receiver.

17. A user device according to claim 15, wherein the user interface block is configured to receive the user selection from at least one of:
a touch screen;
a keyboard;
a mouse; or
software means for marking the image.

18. A user device according to claim 15, wherein the at least one selected region is identified by an address of the region.

19. A user device according to claim 18, wherein each frame of the video signal comprises a plurality of blocks, and the at least one selected region is identified by an address of at least one block.

20. A user device according to claim 15, further comprising a transmitter block configured to transmit the video stream to a decoder and to include in the video stream an indication of the higher quality level of the at least one selected region for use at the decoder.
